(19) United States
(12) Patent Application Publication
(10) Pub. No.: US 2020/0170259 A1
(43) Pub. Date: Jun. 4, 2020

(54) COMPOSITIONS AND METHODS FOR INDUCING PLANT GENE EXPRESSION AND ALTERING PLANT MICROBIOME COMPOSITION FOR IMPROVED CROP PERFORMANCE

(71) Applicant: ADVANCED BIOLOGICAL MARKETING, INC., Geneva, NY (US)

(72) Inventors: Molly Cadle-Davidson, Geneva, NY (US); Andrea Shelley Marino, Pittsford, NY (US)

(73) Assignee: ADVANCED BIOLOGICAL MARKETING, INC., Geneva, NY (US)

(21) Appl. No.: 16/703,626

(22) Filed: Dec. 4, 2019

Related U.S. Application Data
(60) Provisional application No. 62/775,377, filed on Dec. 4, 2018.

(51) Int. Cl. A01N 63/38; A01N 63/22

(52) U.S. Cl. CPC A01N 63/38; C12R 1/885; A01N 63/22

(57) ABSTRACT

The present disclosure relates generally to compositions and methods entailing one or more microbial treatments being applied to crop plants such that changes in plant gene expression and microbiome alteration are induced that stabilize the performance of the treated plant. The present disclosure allows for the use of non-GMO plants in combination with microbial agents or derivatives that signal the plant to upregulate certain gene expression. Thus, reduction of field variability, reduction of plant microbiome diversity, stabilization of plant gene expression, stabilization of yields and stabilization of harvest quality are achieved.

### RELATED APPLICATIONS

None.

### STATEMENT REGARDING FEDERALLY SPONSORED RESEARCH OR DEVELOPMENT

Not Applicable.

### REFERENCE TO SEQUENCE LISTING, TABLE, OR COMPUTER PROGRAM LISTING

Not Applicable.

### TECHNICAL FIELD

The present technology relates generally to compositions, methods and systems entailing one or more microbial agents, metabolites or combinations and derivatives thereof being applied to crop plants.

### BACKGROUND ART

The following description is provided to assist the understanding of the reader. None of the information provided or references cited is admitted to be prior art to the present invention.

Some microbial agents are known to alter plant gene expression via their colonization of plant roots and/or shoots. Changes in plant gene expression can be in root tissue, shoot tissue, or both, and effect the plant phenotypes expressed regardless of what part of the plant is colonized. A set of plant genes known to be upregulated by some microbial agents are those in the Reactive Oxygen (ROS) Cycling pathway resulting in a greater number of protein copies from these genes when sufficient nutrients are available to plants to accommodate such increases in protein synthesis. This increase in ROS cycling capacity allows plants to better mediate stresses such as drought, heat, and salt since these stresses are all ROS generating stresses.

The microbiome of most organisms is composed an assemblage of different species that form an ecological unit (https://en.wikipedia.org/wiki/Holobiont). These include plants and their associated microbial communities; the plant (or other organisms) plus its associated microflora is termed the holobiont (Gopal and Gupta 2016). The complex interactions of microbial communities with their plant host, or the phytobiome (www.phytobiomes.org/roadmap), affects the function and physiology of the host. Understanding the interactions and their effects are critical to developing predictive systems addressing challenges facing modern societies such as hunger and climate change (Blaser et al. 2016). Root and plant genetic make-up and physiology, the environmental milieu and their microbial and genetic communities affect nutrient uptake, water use efficiency, tolerance to a variety of stressors and are directly responsible for many yield-limiting traits (cf) (Adl 2016). The microbes that colonize internally can be pathogenic, symbiotic, or neutral their effects on plants. Further, these organisms may be part of natural microflora of plants, or they may be introduced with the intent of altering plant performance.

Numerous diverse organisms have adopted a symbiotic life style with plant roots, and can contribute markedly to plant growth and performance. Examples include nitrogen fixing Rhizobiaceae, plant growth promoting rhizobacteria (PGPR), Basidiomyeteous fungi in the sebiacales such as Piriformaspora indica, mycorrhizae, and specific strains of Ascomycetous Trichoderma spp (Harman et al. 2004b; Shoresh et al. 2010). Some of these are restricted to associations with specific plants, such as the Rhizobiaceae, while other such as Trichoderma and PGPR are more generalized. All of these diverse organisms appear to have abilities to enhance growth and performance of plants including qualitatively similar physiological and phenotypic responses; comparisons have been made of the of the qualitatively similar plant growth advantages provided by Trichoderma spp., Piriformaspora indica and PGPR include increased shoot and root growth, systemic resistance to disease, enhanced adventitious root growth, enhanced nutrient use efficiency and uptake, and enhanced resistance to oxidative stress. These phenotypic changes are associated with numerous changes in plant gene expression. Mycorrhizae also provide similar benefits and modes of action, cf. Such microbes colonize only root systems but induce systemic changes in plant gene and protein expression, thereby changing the physiology of the plant. Gene expression changes in plants by these diverse organisms result in up-regulation of entire pathways, such as those governing plant redox levels and photosynthetic activity.

Thus, generally speaking, it can be expected that a plant microbial colonist could alter plant cell function such that the stabilization of certain variability of the treated plant may occur. This microbe-plant-herbicide interaction allows for the deployment of microbially-protected crop plants that have stabilized performance criteria in conventional crop settings.

### SUMMARY

The present invention relates generally to compositions, methods and systems entailing one or more microbial agents or their derivatives and metabolites being applied to crop plants such that changes in plant gene expression and in microbial compositions are induced that stabilize plant performance variability.

The present invention allows for the use of non-GMO plants in combination with microbial agents or derivatives that signal the plant to redirect plant resources to stress mitigation genes and processes. As a result, a variability in the yield of the plant is reduced and more stable crop performance is achieved.

The present technology relates generally to compositions, methods and systems entailing one or more microbial agents or their derivatives being applied to crop plants such that changes in plant gene expression and in microbiome composition are induced that result in more stable plant performance. One of many possible examples of this is the use of Trichoderma and/or Bacillus strains to colonize plant roots and increase plant expression of the genes in the Reactive Oxygen Cycling (ROS) pathway.

The embodiments disclosed in this application to achieve the above-mentioned object has various aspects, and the representative aspects are outlined as follows. With parenthetical reference to the corresponding parts, portions or surfaces of the disclosed embodiment, merely for the purposes of illustration and not by way of limitation, the present invention provides a composition comprising one or more microbes, wherein said one or more microbes are Trichoderma virens, Trichoderma atroviride, Trichoderma afroharzianum, Trichoderma strains K1, K2, K3, K4, or K5, and/or some combination thereof.

Further provided is a composition comprising one or more microbe-derived compounds are metabolites including 6-pentyl pyrone, harzianic acid, hydtra 1, harzinolide and/or 1-octene-3-ol, and further including one or more microbes, wherein said one or more microbes are Trichoderma virens, Trichoderma atroviride, Trichoderma afroharzianum, Trichoderma strains K1, K2, K3, K4, or K5, and/or some combination thereof.

In some aspects of the present invention, biological products and strains colonize roots through their endophytic associations and the changes in gene expression. The result is a plant that may upregulate more than 100 specific genes. These upregulated genes are not random, but are coordinately organized into specific plant pathways. The result is a non-engineered plant that nonetheless functions very differently than plants without the microbial agents. The plants thus produced are basically new plants that differs considerably from the same variety without the organism. Likewise, corn and many other crops respond reliably to root colonization by known Trichoderma strains to give the following reliable and reproducible results.

It is therefore another aspect of the present invention to provide A method of stabilizing plant performance variability, comprising selecting one or more plants; and applying to the selected plant or a seed of the plant a microbial treatment, wherein the microbial treatment: (i) upregulates plant gene expression of stress mitigation processes; and (ii) signals to the extant microbial community to initiate a rhizosphere response via alteration of microbiome composition; wherein the plants exposed to the microbial treatment possess decreased variability in plant performance compared to plants that have not been exposed to the microbial treatment.

In one aspect the microbial treatment comprises microbial strains selected from a group consisting of: Trichoderma K1, Trichoderma K2, Trichoderma K3, Trichoderma K4, Trichoderma K5, Bacillus licheniformis, Bacillus amyloliquefaciens Beauvaria bassiana, Metarhizium pingshaence, and combinations thereof.

In another aspect the microbial treatment further comprises providing a microbial composition selected from a group consisting of Trichoderma K5; a combination of Trichoderma K2 and Trichoderma K4; a combination of Trichoderma K5 and Trichoderma K; a combination of Trichoderma K5 and Bacillus amyloliquefaciens; a combination of Trichoderma K1, Trichoderma K2, Trichoderma K3 and Trichoderma K4; a combination of Trichoderma K2, Trichoderma K4 and Beauvaria bassiana; and a combination of Trichoderma K2, Trichoderma K4, Metarhizium pingshaence and combinations thereof.

In one aspect, the microbial treatment further comprises a microbial metabolite. The microbial metabolite is selected from the group consisting of: 6-pentyl pyrone, harzianic acid, hydtra 1, harzinolide and/or 1-octene-3-ol.

In another aspect, the one or more plants, or the seeds from one or more plants, is selected from the group consisting of corn, alfalfa, rice, wheat, barley, oats, rye, cotton, sorghum, sunflower, peanut, potato, sweet potato, bean, pea, chicory, lettuce, endive, cabbage, cannabis, brussels sprout, beet, parsnip, turnip, cauliflower, broccoli, radish, spinach, onion, garlic, eggplant, pepper, celery, carrot, squash, pumpkin, zucchini, cucumber, apple, pear, melon, citrus, strawberry, grape, raspberry, pineapple, soybean, tobacco, tomato, maize, clover, sugarcane, Arabidopsis thaliana, Saintpaulia, petunia, pelargonium, poinsettia, chrysanthemum, carnation, zinnia, roses, snapdragon, geranium, zinnia, lily, daylily, Echinacea, dahlia, hosta, tulip, daffodil, peony, phlox, herbs, ornamental shrubs, ornamental grasses, switchgrass, and turfgrass, or any other plant or seed or crop, or combinations thereof.

In one aspect the microbial treatment imparts plant resistance as selected from a group consisting of: upregulation of plant biological processes, altering plant gene expression antagonistic to plant stress, long term changes in plant gene expression via epigenetic regulation and/or signaling, and combinations thereof. In another aspect, the microbial treatment imparts plant resistance by an upregulated biological process in response to plant stress selected from a group consisting of: abiotic stimulus, water deprivation, high light intensity, oxidative stress/ROS, hydrogen peroxide (H₂O₂), chemical stimulus, and combinations thereof. In another aspect, the microbial treatment imparts plant resistance through upregulation of plant molecular function. In another aspect the microbial treatment imparts plant resistance through upregulation of plant molecular function selected from the group consisting of: glutathione transferase products, monooxygenase activity, oxidoreductase activity, transcription factor activity, iron/sulfur binding, sequence-specific DNA binding, metal ion binding, electron carrier activity, tetrapyrrole binding, nutrient reservoir activity, microRNA activity, and combinations thereof.

In a further aspect, a microbial agent present in the microbial treatment colonizes the root of the plant. The application of the microbial treatment may further comprise coating the plant or the plant seed or the planting medium with the microbial treatment.

In another aspect the application of the microbial treatment is selected from a means or group consisting of broadcast application, aerosol application, spray-dried application, liquid, dry, powder, mist, atomized, semi-solid, gel, coating, lotion, linked or linker material, material, in-furrow application, spray application, irrigation, injection, dusting, pelleting, or coating of the plant or the plant seed or the planting medium with the microbial treatment.

In one aspect, the reduced variability comprises reduction of field level variability. In another aspect the reduced variability is selected from a group consisting of: reduction in the phytobiome of the plant, reduction of the functional diversity of microbial species present in the phytobiome of the plant, comprises stabilization of gene expression of genes selected from the group consisting of: stress mitigation genes, molecular functions genes, biological process genes, and combinations thereof, stabilization of plant yield, stabilization of harvest quality, stabilization of plant gene expression, and combinations thereof.

It is another object of the present invention to provide a microbial treatment composition for stabilization of variability of plant performance, comprising at least one microbial treatment, and a means for localized application of the at least one microbial treatment, wherein the localized application imparts upregulation of gene expression in the plant wherein the plants exposed to the microbial treatment possess increased plant performance compared to plants that have not been exposed to the microbial treatment.

In one aspect the microbial treatment comprises microbial strains selected from the group consisting of: K1 (Trichoderma virens—ATCC #20906); K2 (Trichoderma afroharzian—ATCC # PTA-9708); K3 (Trichoderma afroharzian—ATCC # PTA-9709); K4 (Trichoderma atroviride—ATCC # PAT-9707); and K5 (Trichoderma atroviride—NRRL # B-50520).

In another aspect the microbial treatment further comprises a microbial metabolite selected from a group consisting of: 6-pentyl pyrone, harzianic acid, hydtra 1, harzinolide and/or 1-octene-3-ol.

In one aspect the microbial treatment is selected from the group consisting of Bradyrhizobium spp., Trichoderma spp., Bacillus spp., Pseudomonas spp. and Clonostachys spp. or any combination thereof. In another aspect the microbial treatment imparts plant resistance selected from a group consisting of: upregulation of plant biological processes, altering plant gene expression antagonistic to plant stress, long term changes in plant gene expression via epigenetic regulation and/or signaling, and combinations thereof.

In another aspect the upregulated biological processes are in response to plant stress selected from a group consisting of: abiotic stimulus, water deprivation, high light intensity, oxidative stress/ROS, hydrogen peroxide (H2O2), chemical stimulus, and combinations thereof.

In another aspect, the microbial treatment imparts plant resistance through upregulation of plant molecular function selected from the group consisting of: glutathione transferase products, monooxygenase activity, oxidoreductase activity, transcription factor activity, iron/sulfur binding, sequence-specific DNA binding, metal ion binding, electron carrier activity, tetrapyrrole binding, nutrient reservoir activity, microRNA activity, and combinations thereof.

Further, it is another aspect wherein a microbial agent present in the microbial treatment colonizes the root of the plant. In another aspect the application of the microbial treatment is selected from a means or group consisting of broadcast application, aerosol application, spray-dried application, liquid, dry, powder, mist, atomized, semi-solid, gel, coating, lotion, linked or linker material, material, in-furrow application, spray application, irrigation, injection, dusting, pelleting, or coating of the plant or the plant seed or the planting medium with the microbial treatment.

In one aspect the reduced variability is selected from a group consisting of: reduction of field level variability, reduction in the phytobiome of the plant, reduction of the functional diversity of microbial species present in the phytobiome of the plant, stabilization of gene expression of genes selected from the group consisting of: stress mitigation genes, molecular functions genes, biological process genes, and combinations thereof, stabilization of plant yield, stabilization of harvest quality, stabilization of plant gene expression, and combinations thereof.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 depicts a chart showing soybean yield variability of various treatments particularly reduction in performance variability.

FIG. 2 depicts a chart showing a corn rootworm trial with reduced performance variability of a BT hybrid corn having various applications of microbial agents.

FIG. 3 depicts a chart showing a corn rootworm trial with reduced performance variability of a conventional corn variety having various applications of microbial agents.

FIG. 4 depicts a chart showing Trichoderma reduction of corn performance variability at different nitrogen (N) levels.

FIG. 5 depicts a chart showing reduction of cotton performance variability by application of various microbial agents.

FIG. 6 depicts a chart showing a cotton nematode trial scatter plot of total nematode counts compared to root fresh weight.

FIG. 7 depicts a chart showing a cotton nematode trial scatter plot of total nematode counts compared to plant stand.

FIG. 8 depicts a chart showing potato treatments of microbial agents and the increased presence of high quality potatoes (4-8 oz.).

FIG. 9 depicts a chart showing the data of FIG. 8 with variability of the applicable treatments shown.

FIG. 10 depicts a chart showing potato treatments of microbial agents and the increased presence of low quality potatoes (<4 oz.).

FIG. 11 depicts a chart showing the potato treatment data of FIG. 10 with variability of the applicable treatments shown.

FIG. 12 depicts a chart showing a strawberry trial and the application of microbial treatments to strawberries for the reduction of fruit harvest variability.

FIG. 13 depicts a diagram showing rhizosphere fungal inhabitants in a corn trial of a control, 2-Trichoderma strain treatment (SabrEx), and Trichoderma-metabolite treatment (Omega).

FIG. 14 depicts a diagram showing rhizosphere fungal inhabitants in a corn trial of a control, 2-Trichoderma strain treatment (SabrEx), and Trichoderma-Bacillus treatment (K5AS2).

FIG. 15 depicts a diagram showing bacterial inhabitants in a corn trial with a control, 2-Trichoderma strain treatment (SabrEx), Trichoderma-Bacillus treatment (K5AS2), and Trichoderma-metabolite treatment (Omega).

FIG. 16 depicts lifestyle surveys of rhizosphere inhabitants in a corn trial with a control, 2-Trichoderma strain treatment (SabrEx), Trichoderma-Bacillus treatment (K5AS2), and Trichoderma-metabolite treatment (Omega).

FIG. 17 depicts a representation of all gene expression in corn seedlings exposed to various seed treatments versus an untreated seed in both standard and drought conditions.

FIGS. 18A-B depict multidimensional scaling plots of corn gene expression when colonized by Trichoderma, particularly, 2-Trichoderma strain treatment (SabrEx) and untreated in unstressed conditions.

FIGS. 19A-B depict multidimensional scaling plots of corn gene expression when colonized by Trichoderma, particularly, 2-Trichoderma strain treatment (SabrEx) and untreated in drought conditions.

FIG. 20 depicts a flow diagram of biological processes upregulated in maize having drought stress when treated with 2-Trichoderma strain treatment (SabrEx).

FIG. 21 depicts a flow diagram of shoot response upregulated in maize treated with 2-Trichoderma strain treatment (SabrEx), including response to: abiotic stimulus, water deprivation, high light intensity, oxidative stress/ROS, and H₂O₂.

FIG. 22 depicts a flow diagram of shoot response upregulated in maize treated with a Trichoderma metabolite treatment, including response to: Abiotic stimulus, water deprivation, and chemical stimulus.

FIG. 23 depicts a flow diagram of molecular functions upregulated in corn treated with 2-Trichoderma strain treatment (SabrEx).

FIG. 24 depicts a flow diagram of molecular functions upregulated in corn treated with Trichoderma metabolite treatment.

FIG. 25 depicts a table of changes in corn gene expression versus an untreated control in RNAseq experiments of FIGS. 20-24.

### DESCRIPTION OF THE PREFERRED EMBODIMENTS

It is to be appreciated that certain aspects, modes, embodiments, variations and features of the invention are described below in various levels of detail in order to provide a substantial understanding of the present invention.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

In practicing the present invention, many conventional techniques in molecular biology, protein biochemistry, cell biology, immunology, microbiology and recombinant DNA are used. These techniques are well-known and are explained in, e.g., Current Protocols in Molecular Biology, Vols. I-III, Ausubel, Ed. (1997); Sambrook et al., Molecular Cloning: A Laboratory Manual, Second Ed. (Cold Spring Harbor Laboratory Press, Cold Spring Harbor, N.Y. (1989)); DNA Cloning: A Practical Approach, Vols. I and II, Glover, Ed. (1985); Oligonuchotide Synthesis, Gait, Ed. (1984); Nucleic Acid Hybridization, Hames & Higgins, Eds. (1985); Transcription and Translation, Hames & Higgins, Eds. (1984); Animal Cell Culture, Freshney, Ed. (1986); Immobilized Cells and Enzymes (IRL Press, 1986); Perbal, A Practical Guide to Molecular Cloning; the series, Meth. Enzymol., (Academic Press, Inc., 1984); Gene Transfer Vectors for Mammalian Cells, Miller & Calos, Eds. (Cold Spring Harbor Laboratory, New York (1987)); and Meth. Enzymol., Vols. 154 and 155, Wu & Grossman, and Wu, Eds., respectively. Methods to detect and measure levels of polypeptide gene expression products (i.e., gene translation level) are well-known in the art and include the use polypeptide detection methods such as antibody detection and quantification techniques. (See also, Strachan & Read, Human Molecular Genetics, Second Edition. (John Wiley and Sons, Inc., New York (1999).)

Unless defined otherwise, all technical and scientific terms used herein generally have the same meaning as commonly understood by one of ordinary skill in the art to which this invention belongs. As used in this specification and the appended claims, the singular forms “a,” “an” and “the” include plural referents unless the content clearly dictates otherwise. For example, reference to “a cell” includes a combination of two or more cells, and the like. Generally, the nomenclature used herein and the laboratory procedures in cell culture, molecular genetics, organic chemistry, analytical chemistry and nucleic acid chemistry and hybridization described below are those well-known and commonly employed in the art. All references cited herein are incorporated herein by reference in their entireties and for all purposes to the same extent as if each individual publication, patent, or patent application was specifically and individually incorporated by reference in its entirety for all purposes.

In practicing the present invention, many conventional techniques in molecular biology, protein biochemistry, cell biology, immunology, microbiology and recombinant DNA are used. These techniques are well-known and are explained in, e.g., Current Protocols in Molecular Biology, Vols. I-III, Ausubel, Ed. (1997); Sambrook et al., Molecular Cloning: A Laboratory Manual, Second Ed. (Cold Spring Harbor Laboratory Press, Cold Spring Harbor, N.Y., 1989); DNA Cloning: A Practical Approach, Vols. I and II, Glover, Ed. (1985); Oligonucleotide Synthesis, Gait, Ed. (1984); Nucleic Acid Hybridization, Hames & Higgins, Eds. (1985); Transcription and Translation, Hames & Higgins, Eds. (1984); Animal Cell Culture, Freshney, Ed. (1986); Immobilized Cells and Enzymes (IRL Press, 1986); Perbal, A Practical Guide to Molecular Cloning; the series, Meth. Enzymol., (Academic Press, Inc., 1984); Gene Transfer Vectors for Mammalian Cells, Miller & Calos, Eds. (Cold Spring Harbor Laboratory, N Y, 1987); and Meth. Enzymol., Vols. 154 and 155, Wu & Grossman, and Wu, Eds., respectively.

Definitions. The definitions of certain terms as used in this specification are provided below. Definitions of other terms may be found in the Illustrated Dictionary of Immunology, 2nd Edition (Cruse, J. M. and Lewis, R. E., Eds., Boca Raton, Fla.: CRC Press, 1995). Unless indicated otherwise, the term “biomarker” when used herein refers to the human biomarker, e.g., a human protein and gene. Such definitions of certain terms as used in this specification are provided below. Unless defined otherwise, all technical and scientific terms used herein generally have the same meaning as commonly understood by one of ordinary skill in the art to which this invention belongs.

As used in this specification and the appended claims, the singular forms “a”, “an” and “the” include plural referents unless the content clearly dictates otherwise. For example, reference to “a cell” includes a combination of two or more cells, and the like.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the enumerated value.

As used herein, the “administration” of an agent, microbe, compositions, drug, or peptide to a subject plant and/or plant system includes any route or modality of introducing or delivering the agent or composition to perform its intended function.

As used herein, the term “amino acid” includes naturally-occurring amino acids and synthetic amino acids, as well as amino acid analogs and amino acid mimetics that function in a manner similar to the naturally-occurring amino acids. Naturally-occurring amino acids are those encoded by the genetic code, as well as those amino acids that are later modified, e.g., hydroxyproline, γ-carboxyglutamate, and O-phosphoserine. Amino acid analogs refers to compounds that have the same basic chemical structure as a naturally-occurring amino acid, i.e., an α-carbon that is bound to a hydrogen, a carboxyl group, an amino group, and an R group, e.g., homoserine, norleucine, methionine sulfoxide, methionine methyl sulfonium. Such analogs have modified R groups (e.g., norleucine) or modified peptide backbones, but retain the same basic chemical structure as a naturally-occurring amino acid. Amino acid mimetics refers to chemical compounds that have a structure that is different from the general chemical structure of an amino acid, but that functions in a manner similar to a naturally-occurring amino acid. Amino acids can be referred to herein by either their commonly known three letter symbols or by the one-letter symbols recommended by the IUPAC-IUB Biochemical Nomenclature Commission.

As used herein, the terms “amplification” or “amplify” mean one or more methods known in the art for copying a target nucleic acid, e.g., biomarker mRNA, thereby increasing the number of copies of a selected nucleic acid sequence. Amplification may be exponential or linear. A target nucleic acid may be either DNA or RNA. The sequences amplified in this manner form an “amplicon.” While the exemplary methods described hereinafter relate to amplification using the polymerase chain reaction (PCR), numerous other methods are known in the art for amplification of nucleic acids (e.g., isothermal methods, rolling circle methods, etc.). The skilled artisan will understand that these other methods may be used either in place of, or together with, PCR methods. See, e.g., Saiki, “Amplification of Genomic DNA” in PCR Protocols, Innis et al., Eds., Academic Press, San Diego, Calif. 1990, pp. 13-20; Wharam et al., Nucleic Acids Res., 2001, 29(11):E54-E54; Hafner et al., Biotechniques 2001, 30(4):852-6, 858, 860; Zhong et al., Biotechniques, 2001, 30(4):852-6, 858, 860.

As used herein, the term “aggregation” or “cell aggregation” refers to a process whereby biomolecules, such as polypeptides, or cells stably associate with each other to form a multimeric, insoluble complex, which does not disassociate under physiological conditions unless a disaggregation step is performed.

As used herein, the terms “amphipathic” or “amphiphilic” are meant to refer to any material that is capable of polar and non-polar, or hydrophobic and hydrophilic, interactions. These amphipathic interactions can occur at the same time or in response to an external stimuli at different times. For example, when a specific material, coating, a linker, matrix or support, is said to be “amphipathic,” it is meant that the coating can be hydrophobic or hydrophilic depending upon external variables, such as, e.g., temperature.

As used herein, the phrase “difference of the level” refers to differences in the quantity of a particular marker, such as a cell surface antigen, biomarker protein, nucleic acid, or a difference in the response of a particular cell type to a stimulus, e.g., a change in surface adhesion, in a sample as compared to a control or reference level. In illustrative embodiments, a “difference of a level” is a difference between the level of a marker present in a sample as compared to a control of at least about 1%, at least about 2%, at least about 3%, at least about 5%, at least about 10%, at least about 15%, at least about 20%, at least about 25%, at least about 30%, at least about 35%, at least about 40%, at least about 50%, at least about 60%, at least about 75%, at least about 80% or more.

As used herein, the terms “expression” or “gene expression” refer to the process of converting genetic information encoded in a gene into RNA, e.g., mRNA, rRNA, tRNA, or snRNA, through transcription of the gene, i.e., via the enzymatic action of an RNA polymerase, and for protein encoding genes, into protein through translation of mRNA. Gene expression can be regulated at many stages in the process. “Up-regulation” or “activation” refers to regulation that increases the production of gene expression products, i.e., RNA or protein, while “down-regulation” or “repression” or “knock-down”refers to regulation that decreases production. Molecules, e.g., transcription factors that are involved in up-regulation or down-regulation are often called “activators” and “repressors,” respectively.

As used herein, the term “composition” refers to a product with specified ingredients in the specified amounts, as well as any product which results, directly or indirectly, from combination of the specified ingredients in the specified amounts.

As used herein, the terms “produce”, “crops”, “food component”, “system component”, “augmentation variable” or “subject” refer to a plant, fungus, microbial colony, mammal, such as a human, but can also be another animal such as a domestic animal, e.g., a dog, cat, or the like, a farm animal, e.g., a cow, a sheep, a pig, a horse, or the like, or a laboratory animal, e.g., a monkey, a rat, a mouse, a rabbit, a guinea pig, or the like.

As used herein, the terms “matrix” or “support” or “hydrogel matrix” are used interchangeably, and encompass polymer and non-polymer based hydrogels, including, e.g., poly(hyaluronic acid), poly(sodium alginate), poly(ethylene glycol), diacrylate, chitosan, and poly(vinyl alcohol)-based hydrogels. “Hydrogel” or “gel” is also meant to refer to all other hydrogel compositions disclosed herein, including hydrogels that contain polymers, copolymers, terpolymer, and complexed polymer hydrogels, i.e., hydrogels that contain one, two, three, four or more monomeric or multimeric constituent units. Hydrogels are typically continuous networks of hydrophilic polymers that absorb water.

As used herein, the term “reference level” refers to a level or measurement of a substance or variable which may be of interest for comparative purposes. In some embodiments, a reference level may be a specified moisture content as an average of the moisture content taken from a control subject/plant. In other embodiments, the reference level may be the level in the same subject/plant at a different time, e.g., a time course of administering or applying a particular composition or formulation.

As used herein, the terms “treating” or “treatment” or “alleviation” refer to both therapeutic treatment and prophylactic or preventative measures, where the objective is to prevent or slow down (lessen) the targeted disease, condition or disorder. A plant is successfully “treated” for a disorder if, after receiving therapeutic intervention/application according to the methods of the present invention, the subject/plant shows observable and/or measurable reduction in or absence of one or more targeted disease, condition or disorder.

An “isolated” or “purified” polypeptide or peptide is substantially free of cellular material or other contaminating polypeptides from the cell or tissue source from which the agent is derived, or substantially free from chemical precursors or other chemicals when chemically synthesized. For example, an isolated aromatic-cationic peptide would be free of materials that would interfere with diagnostic or therapeutic uses of the agent. Such interfering materials may include enzymes, hormones and other proteinaceous and nonproteinaceous solutes.

As used herein, the terms “polypeptide”, “peptide” and “protein” are used interchangeably herein to mean a polymer comprising two or more amino acids joined to each other by peptide bonds or modified peptide bonds, i.e., peptide isosteres. Polypeptide refers to both short chains, commonly referred to as peptides, glycopeptides or oligomers, and to longer chains, generally referred to as proteins. Polypeptides may contain amino acids other than the 20 gene-encoded amino acids. Polypeptides include amino acid sequences modified either by natural processes, such as post-translational processing, or by chemical modification techniques that are well known in the art.

As used herein, the term “simultaneous” use refers to the administration of at least two active ingredients by the same route and at the same time or at substantially the same time.

As used herein, the term “separate” use refers to an administration of at least two active ingredients at the same time or at substantially the same time by different routes.

As used herein, the term “sequential” use refers to administration of at least two active ingredients at different times, the administration route being identical or different. More particularly, sequential use refers to the whole administration of one of the active ingredients before administration of the other or others commences. It is thus possible to administer one of the active ingredients over several minutes, hours, or days before administering the other active ingredient or ingredients. There is no simultaneous treatment in this case.

As used herein, the term “p-value” or “p” refers to a measure of probability that a difference between groups happened by chance. For example, a difference between two groups having a p-value of 0.01 (or p=0.01) means that there is a 1 in 100 chance the result occurred by chance. In illustrative embodiments, suitable p-values include, but are not limited to, 0.1, 0.05, 0.025, 0.02, 0.01, 0.005, 0.001, and 0.0001. In suitable embodiments, and throughout the Examples provided herein, letters of significance are at P=0.10 with the R studio interface.

The present invention relates to, inter alia, the discovery and development of a biological system for protection of plants against variability in yield. More generally, it describes a method of delivering an agriculturally relevant signal via colonization by a microbial symbiont. This signal can then be leveraged to change host plant gene expression resulting in plants with reduced variability in yield and trending towards better quality agricultural products (e.g., potatoes, strawberries).

The concepts underlying the induction of stress resistance in plants are unique. Plants suffer from accumulation of (ROS) as a consequence of stress, such as drought, salt, temperature or flooding, and as a by-product of over-excitation of photosynthetic systems. Thus, the internal environment of plants frequently contain an unfavorable redox balance. The beneficial organisms utilized by the present invention induce changes in plant gene expression including upregulation of entire pathways. Among those pathways that are enhanced are as well as stress mitigation genes, molecular functions genes, biological process genes, and combinations thereof.

In addition, several lines of evidence indicate that the total photosynthetic machinery in plants is enhanced (Shoresh and Harman, 2008, Vargas, Mandawe, et al., 2009). Photosynthesis itself gives rise to ROS as a by-product of over-excitation of photosynthetic pigments, and so also results in ROS.

The present invention entails a method comprising the use of a microbe inoculant or foliar spray to induce changes in plant gene expression and in plant microbiome composition that cause the plant to demonstrate a reduced variability in plant performance, such as yield. In one embodiment, Trichoderma afroharzianum strain (ATCC PTA9709) is used as a seed treatment. In another embodiment, plants colonized with T. afroharzianum strain (ATCC PTA9708), T. atroviridae strain (ATCC PTA9707) or a combination of the two, or treated with a Trichoderma metabolite, including 6-pentyl pyrone, harzianic acid, hydtra 1, harzinolide and/or 1-octene-3-ol, increases expression of genes relating to stress mitigation genes, molecular functions genes, biological process genes, and combinations thereof.

In another embodiment, the present invention provides a method of stabilizing plant performance variability, comprising: a. selecting one or more plants; and b. applying to the plant a microbial treatment, wherein the microbial treatment: (upregulates plant gene expression of stress mitigation processes; and (ii) separately, simultaneously, or sequentially signals to the extant microbial community to initiate a rhizosphere response; wherein the plants exposed to the microbial treatment possess decreased variability in plant performance compared to plants that have not been exposed to the microbial treatment. The plant may be corn, alfalfa, rice, wheat, barley, oats, rye, cotton, sorghum, sunflower, peanut, potato, sweet potato, bean, pea, chicory, lettuce, endive, cabbage, brussels sprout, beet, parsnip, turnip, cauliflower, broccoli, radish, spinach, onion, garlic, eggplant, pepper, celery, carrot, squash, pumpkin, zucchini, cucumber, apple, pear, melon, citrus, strawberry, grape, raspberry, pineapple, soybean, tobacco, tomato, maize, clover, sugarcane, Arabidopsis thaliana, Saintpaulia, petunia, pelargonium, poinsettia, chrysanthemum, carnation, zinnia, roses, snapdragon, geranium, zinnia, lily, daylily, Echinacea, dahlia, hosta, tulip, daffodil, peony, phlox, herbs, ornamental shrubs, ornamental grasses, switchgrass, and turfgrass, or any other plant or seed or crop, or combinations thereof.

In another embodiment, the biological mediator may include one or more of: SABREX, K5AS2, OMEGA, plant metabolites, microbial metabolites, fungal metabolites, T. harzianum, T. atroviride, T. gamsii, B. amyloliquifaciens, microbes, one or more bacterial species, fungal species, yeast species, cellular components, metabolites, compounds, surfactants, emulsifiers, metals, K1, K2, K3, K4, K5, AS1, AS2, AS3, AS4, AS5, Trichoderma viride strain NRRL B-50520, Trichoderma harzianum strain RR17Bc (ATCC accession number PTA 9708), Trichoderma harzianum strain F11Bab (ATCC accession number PTA 9709), Trichoderma atroviride strain WW10TC4 (ATCC accession number PTA 9707), Bacillus spp., Bacillus amyloliquifaciens strain AS2 and or any other compositions, mixtures, agents described herein, and/or combinations thereof.

In another embodiment the biological mediator is selected from the group consisting of Bradyrhizobium spp., Trichoderma spp., Bacillus spp., Pseudomonas spp. and Clonostachys spp. or any combination thereof. In yet another embodiment the biological mediator is selected from the group consisting of T. harzianum (T22), T. harzianum strain K2 (PTA ATCC 9708), T. atroviride strain K4 (PTA ATCC 9707), T. viride strain K5, T. viride strain NRRL B-50520, T. harzianum strain RR17Bc (ATCC accession number PTA 9708), T. harzianum strain F11Bab (ATCC accession number PTA 9709), T. atroviride strain WW10TC4 (ATCC accession number PTA 9707), Bacillus amloliqofaciens AS1, AS2 and/or AS3, or any combination thereof.

In another embodiment, the microbial agent colonizes the root of the plant.

In one embodiment of the present invention the application of the biological mediator may include the following: broadcast application, aerosol application, spray-dried application, liquid, dry, powder, mist, atomized, semi-solid, gel, coating, lotion, linked or linker material, material, in-furrow application, spray application, irrigation, injection, dusting, pelleting, or coating of the plant or the plant seed or the planting medium with the agent. In another embodiment the metabolite or extracts or culture filtrate to mediate plant herbicide resistance fungus/bacterium.

Auxins are required plant hormones that when exogenously applied at high concentrations lead to unregulated growth and, in the case of herbicides, plant death. Biologicals such as Trichoderma and other beneficial microbes signal to their host plants via auxin and other plant hormones. Further, these microbes stimulate alterations in plant gene expression that include upregulation of additional plant hormones and the enzyme Glutathione S-transferase (GST)(Deng and Hatzios 2002, Sharma, Sahoo et al. 2014). GST belongs to a large gene family present in both plants and animals. In plants, the various forms of GST function to mitigate plant stress of most all types as well as regulate hormone-induced plant growth. Thus, colonization of a plant by the appropriate beneficial microbe can stimulate the plant to produce a massive root system via hormone signaling yet prevent the over stimulation perhaps by the over expression of GST. GST is also known to conjugate multiple classes of herbicides that are subsequent sequestered in the plant vacuole. Taking these factors into account, GST could be considered the nexus between multiple plant systems and an effective control point in herbicide safening.

GMO plants can be created wherein microbial agent signaling molecule upregulate expression of novel gene sets by altering said gene promoter sequences, plant receptor molecules, plant receptor-signal transduction interactions. Therefore, the same microbial agent will trigger a novel set of gene expression changes. This novel set of genes can mitigate the effects of existing, known, or newly designed herbicides.

### EXAMPLES

The present invention is further illustrated by the following examples, which should not be construed as limiting in any way.

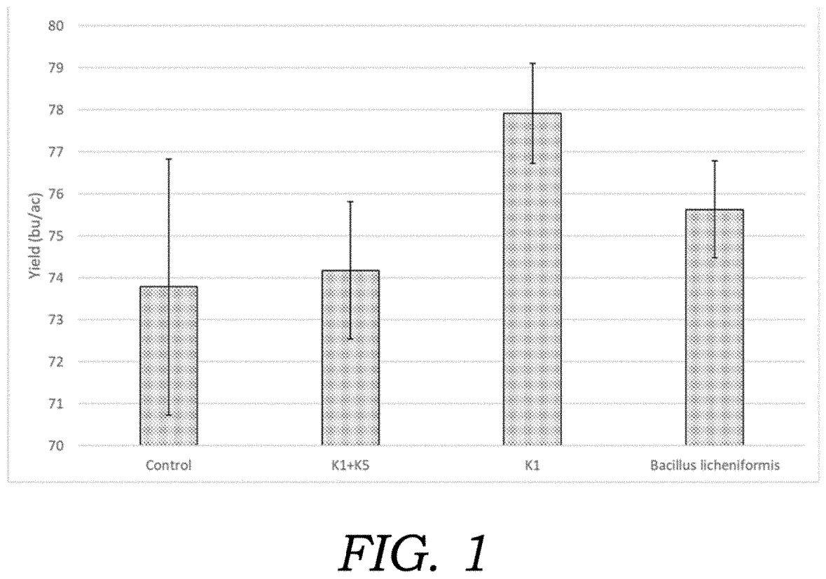

FIG. 1 depicts a chart showing soybean yield variability of various treatments. In particular, FIG. 1 illustrates the yield (e.g., a respective bar), and a respective yield variability (e.g., an error bar) of soybean when treated with various microbial agents or compositions (i.e., microbes). The soybean was treated with no microbial agent (e.g., “control”), K1+K5, K1 only, and Bacillus licheniformis (“Bacillus strains”). When ABM Trichoderma strains (K1 and/or K5) are applied as seed treatments, the Soybean yield variability is reduced. A direct effect of the seed treatment occurs at the early growth stages where fungal or bacterial spores germinate shortly after planting. The microbial agents multiply, growing in and around the developing plant root system and produce chemical signal molecules (e.g., “metabolites”) that are perceived by the host plant and by other microbes in the environment, including the phytobiome and the rhizosphere. The effects shown in FIG. 1 including stabilization of soybean yields mean that the interactions between the microbial agents and the host plant have long term impacts on plant development and physiology.

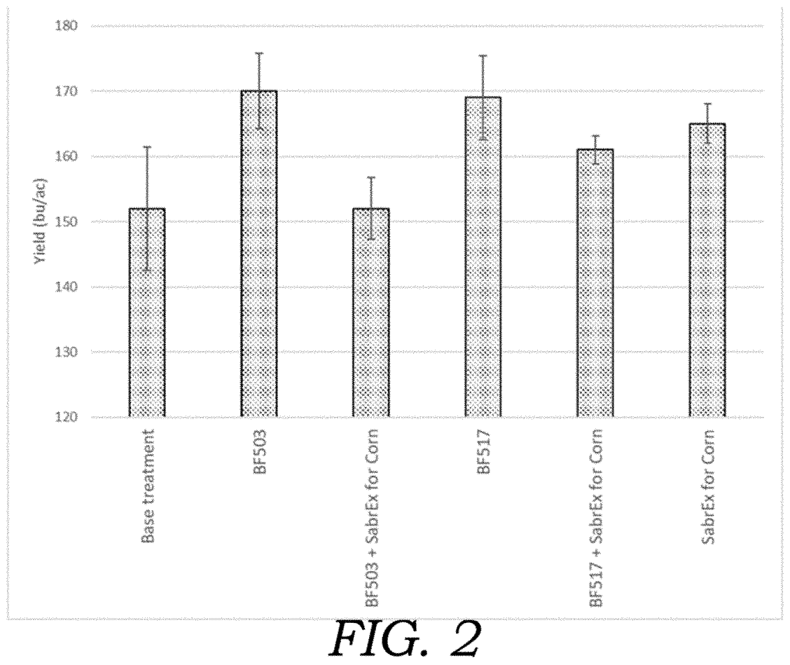

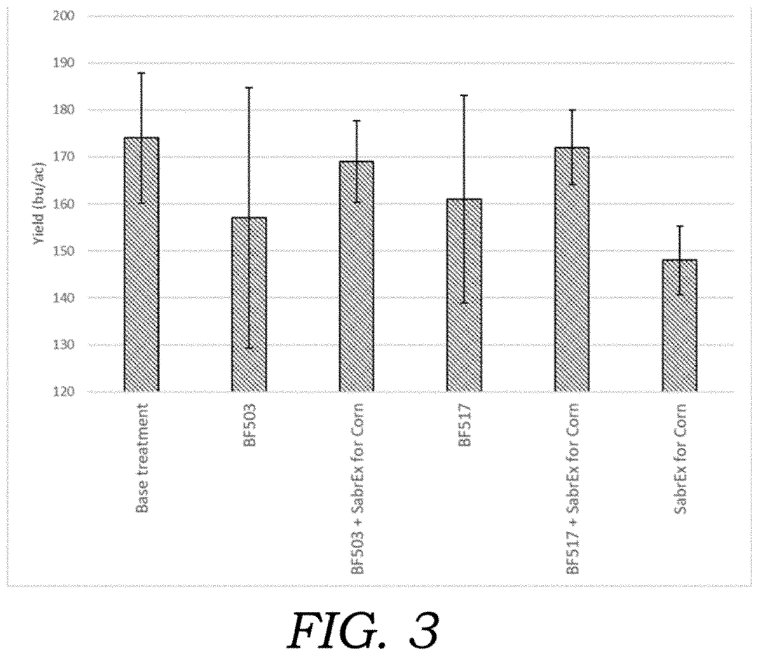

FIG. 2 depicts a chart showing a corn rootworm trial with reduced performance variability of a BT hybrid corn having various applications of microbial agents. FIG. 3 depicts a chart shown a corn rootworm trial with reduced performance variability of a conventional corn variety having various applications of microbial agents. In particular, ABM microbes were applied as seed treatments, and the corn yields are shown in the respective bar graphs, and the variability in the yields are shown by respective error bars. The base treatments in each of the charts had no treatment (i.e., no microbial agents were applied). As shown, the corn yields and variability in yield was reduced, when seed treatments with ABM microbes were applied. Trichoderma strain treatment for corn, containing 2 ABM Trichoderma strains were found to consistently reduce yield variability regardless of whether the corn hybrid is GMO (containing BT) or conventional. Not all microbial agents show this effect, however. For the conventional hybrid strains treated with BF503 (e.g., Beauvaria bassiana) or BF517 (Metarhizium pingshaence), the yield variability in the conventional hybrid strains increased. But compared to the Base treatment, for the conventional hybrid strains, when BF503 or BF517 were combined with Trichoderma strain treatment for Corn, the yield variability was reduced.

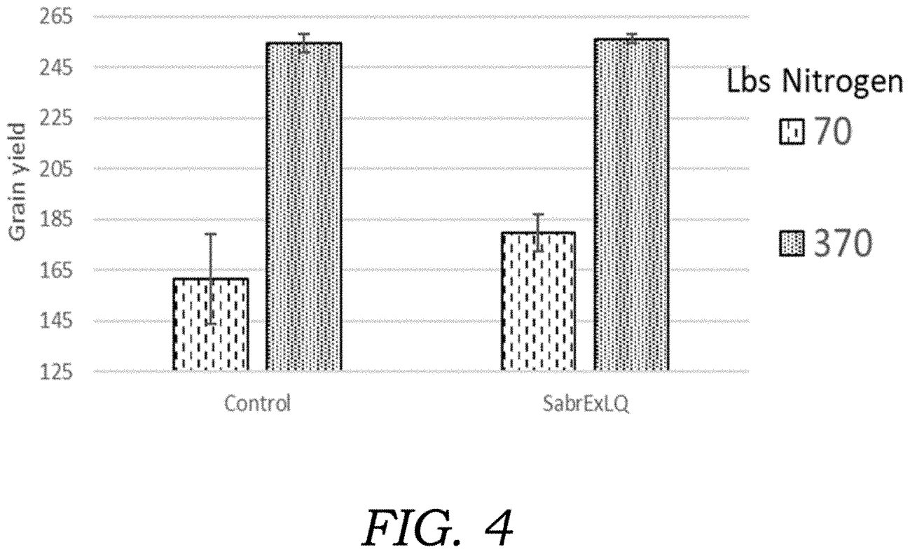

FIG. 4 depicts a chart showing a corn rootworm trial with reduced performance variability at different nitrogen (N) applications in terms of pounds per acre (70#, 30#). In particular, variability of corn yields and the reduction of this variability by ABM microbial agents applied as seed treatments with respect to Nitrogen application is shown here. The control had no microbial agents applied. As shown, the Trichoderma strain treatment for Corn yield variability was consistently reduced at both high the low Nitrogen applications levels—Trichoderma strain treatment liquid formulation. The Trichoderma strain treatment for Corn contains 2 ABM Trichoderma strains.

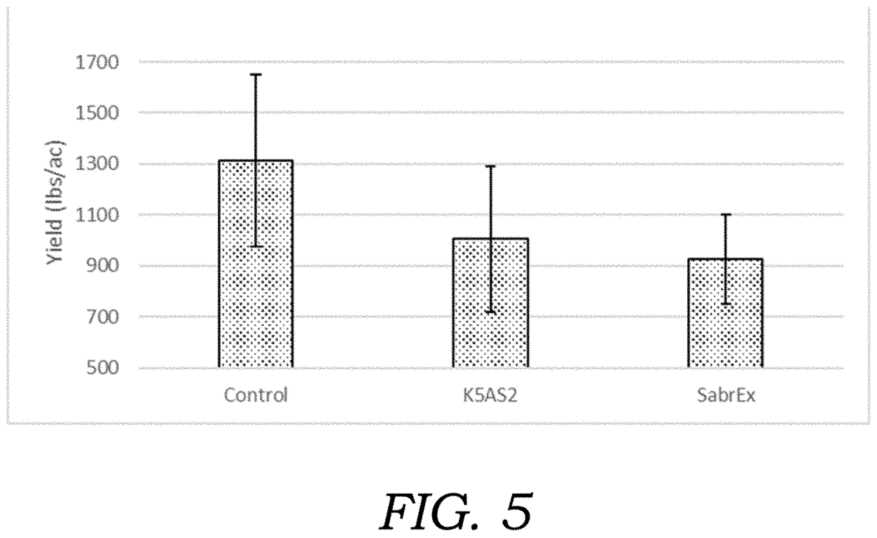

FIG. 5 depicts a chart showing reduction of cotton performance variability using various microbial agents. ABM microbes were applied as seed treatments, and the cotton yields are shown in the respective bar graphs, and the variability in the yields are shown by respective error bars. The control had no treatment (i.e., no microbial agents were applied). The K5AS2 treatment contains ABM Trichoderma and Bacillus amyloliquefaciens, while the Trichoderma strain treatment for Corn contains 2 ABM Trichoderma strains. Trichoderma strain treatment for corn consistently reduces yield variability.

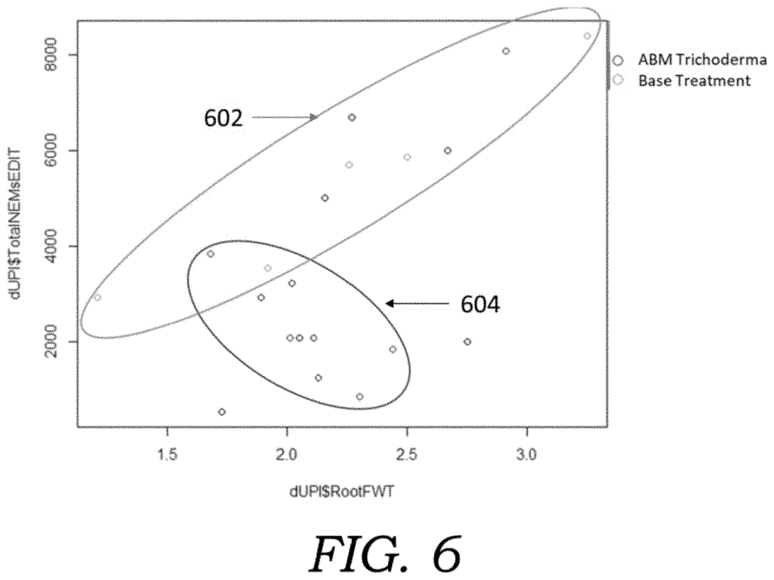

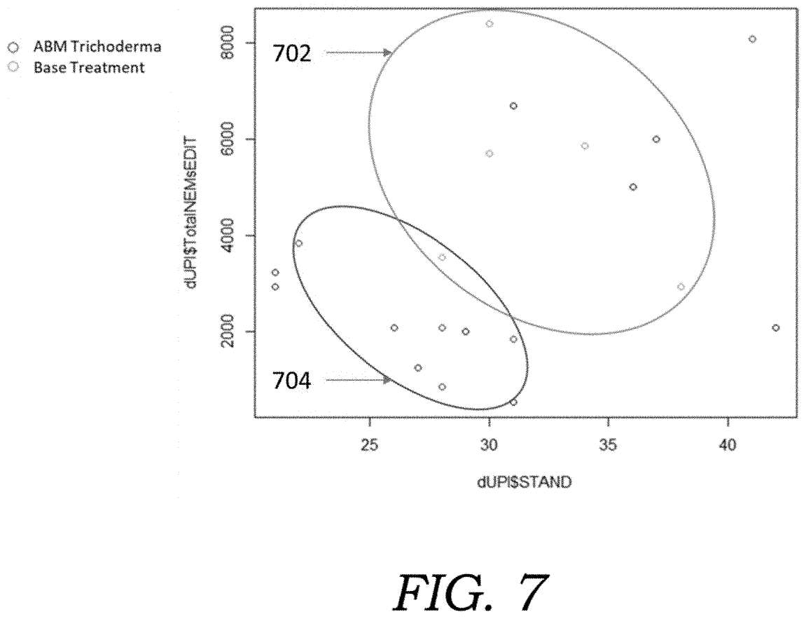

FIG. 6 depicts a chart showing a cotton nematode trial scatter plot of total nematode counts compared to root fresh weight. In particular, the region 602 captures the base treatment where no microbial agents were applied and the region 604 captures the ABM Trichoderma treatment. The plot in FIG. 6 shows a reduction in observation spread, or variability, correlating with applications of the ABM microbial treatment. FIG. 7 depicts a chart shown a cotton nematode trail scatter plot of total nematode counts compared to plant stand. Region 702 captures the base treatment where no microbial agents were applied and the region 704 captures the ABM Trichoderma treatment. The plot in FIG. 7 shows a reduction in observation spread, or variability, correlating with application of the ABM microbial treatment.

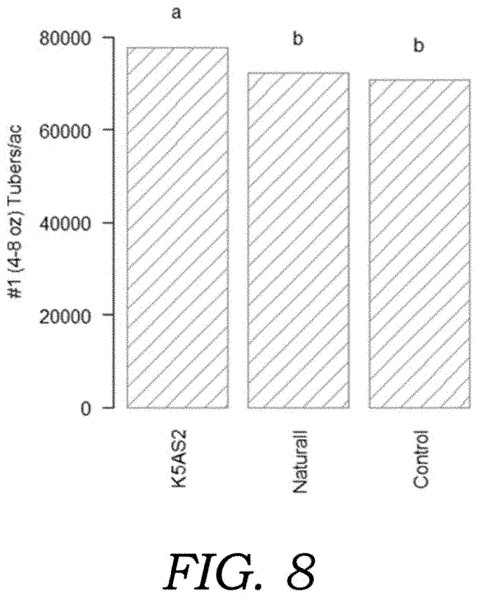

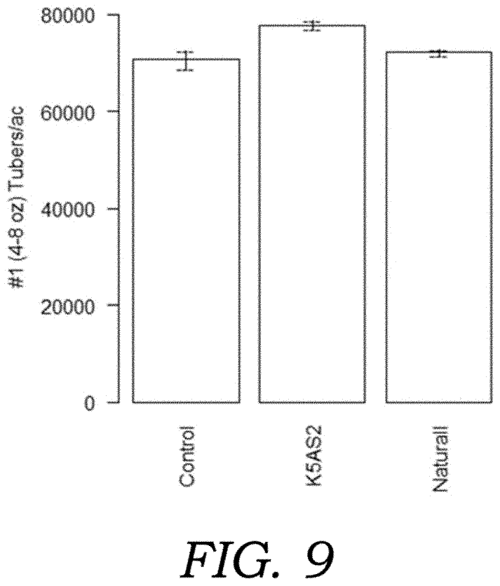

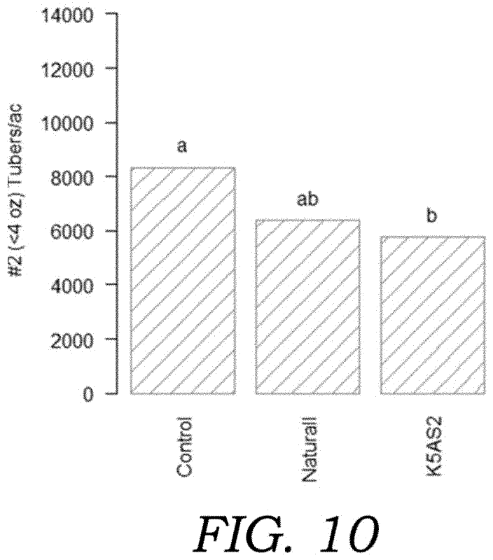

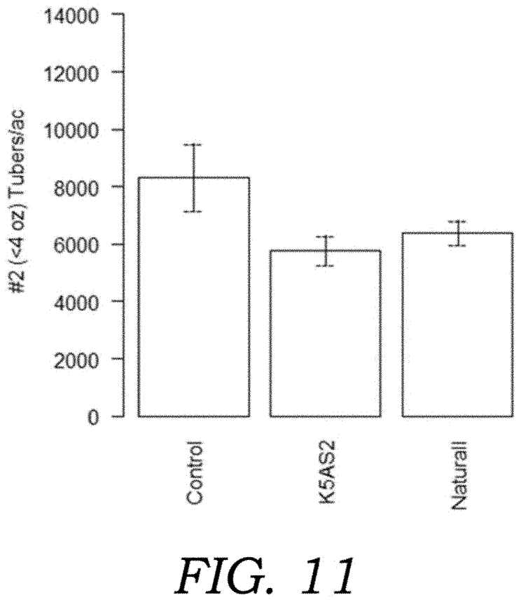

FIG. 8 depicts a chart shown potato treatments of microbial agents and the increased presence of high quality potatoes (4-8 oz.) wherein the and FIG. 9 depicts a chart showing the data of FIG. 8 with variability of the applicable treatments shown (i.e. the error bars). FIG. 10 depicts a chart shown potato treatments of microbial agents and the increased presence of low quality potatoes (<4 oz.) and FIG. 11 depicts a chart shown the data of FIG. 10 with variability of the applicable treatments shown (error bars). Potato yield trials showed increased presence of high quality potatoes (4-8 oz.) (FIGS. 8 and 9) and a decreased presence of low quality potatoes (<4 oz) (FIGS. 10 and 11) with the application of ABM Trichoderma and Bacillus seed piece treatments. In addition, the variability of these treatments was reduced for both quality characters by the application of ABM Trichoderma and Bacillus seed piece treatments. NATURALL is a 4-Trichoderma strain vegetable product sold by Advanced Biological Marketing and K5AS2 contains both a Trichoderma strain and a Bacillus amyloliquefaciens strain.

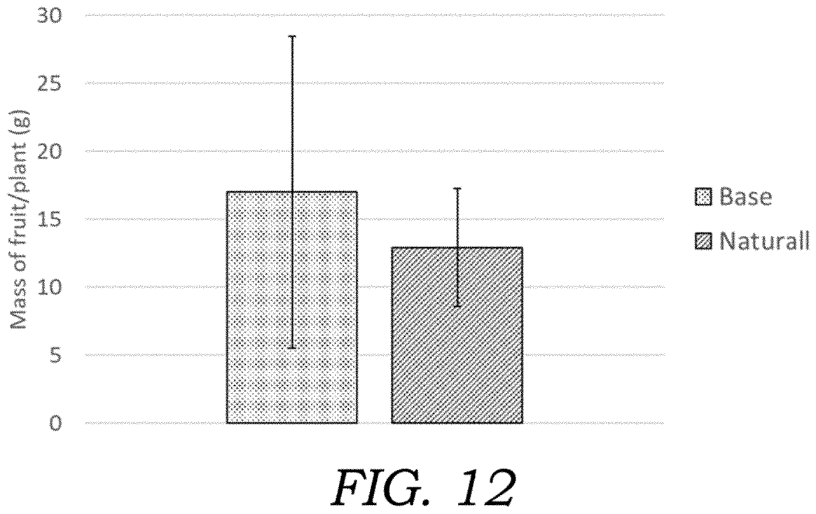

FIG. 12 depicts a chart shown a strawberry trial and the application of microbial treatments to strawberries for the reduction of fruit harvest variability. In particular, FIG. 12 illustrates a mass of fruit/plant (e.g., a respective bar), and respective yield variability (e.g., an error bar) of strawberry when treated with various microbial agents or compositions. The strawberry yield trial with yield being measured at the first fruits harvest showed reduced variability in observations. The base treatment received no microbial agent treatment. NATURALL was applied as a root dip to the crowns prior to planting and as a foliar spray.

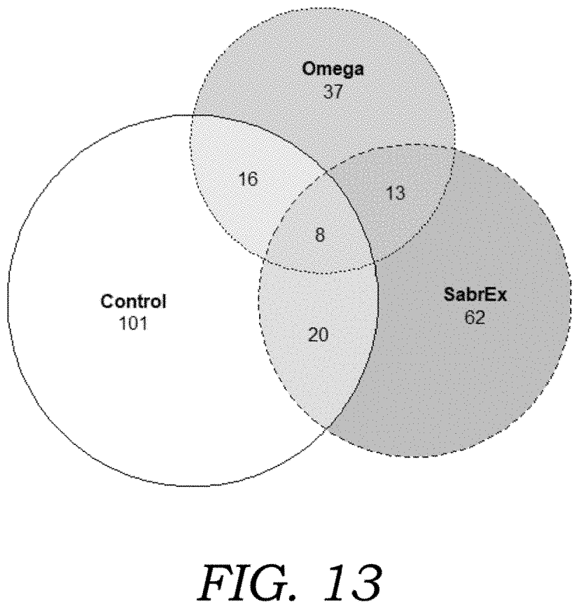

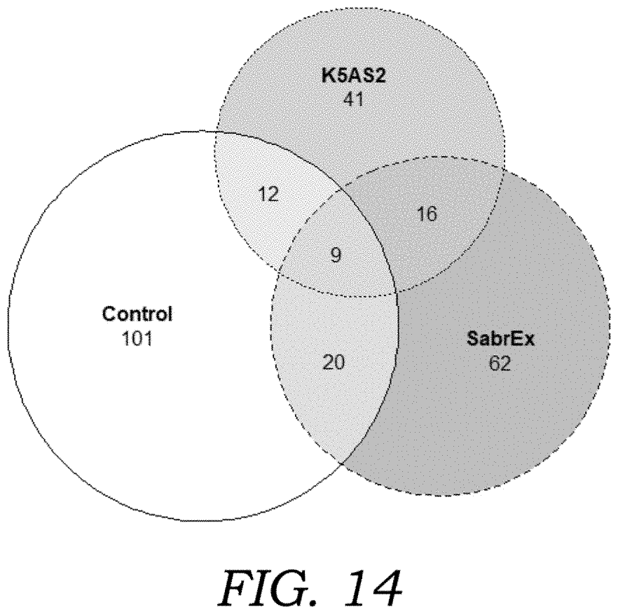

FIG. 13 depicts a Euler diagram showing rhizosphere fungal inhabitants in a corn trial of a control, 2-Trichoderma strain treatment (SabrEx), and Trichoderma-metabolite treatment (Omega). Numbers within the diagram represent the observed number of fungal organisms specifically present the applicable specific treatment. Areas where the circles overlap show numbers of organism in common between the multiple treatments. FIG. 14 depicts a Euler diagram showing rhizosphere fungal inhabitants in a corn trial of a control, 2-Trichoderma strain treatment (SabrEx), and Trichoderma-Bacillus treatment (K5AS2). Holobiont composition is reduced in complexity when colonized by Trichoderma, and/or Bacillus or when exposed to microbial metabolite signal molecule. As with FIG. 13, numbers within the diagram represent the observed number of fungal organisms specifically present the applicable specific treatment. Areas where the circles overlap show numbers of organism in common between the multiple treatments. Observations include: a reduction in the number of rhizosphere fungal species present in the field setting when ABM Trichoderma or Bacillus strains, or a Trichoderma metabolite (1-Octene-3-ol) is applied as a seed treatment; and a reduction in the number of lifestyles of rhizosphere microbial agents. Observations also include that the pattern of microbial lifestyles in the rhizosphere is dependent on whether the seed treatment was Trichoderma only or Trichoderma+Bacillus.

Still referring to FIGS. 13 and 14, a survey of rhizosphere fungal inhabitants in a corn trial with control, Trichoderma strain treatment for corn (2 ABM Trichoderma strains), K5AS2 (ABM Trichoderma+Bacillus strains), or Trichoderma metabolite seed treatments were made. The rhizosphere inhabitants were surveyed at approximately the R1 stage or 10 weeks after planting. A small number of fungal species were present in all the treatments, as is represented in the Euler diagrams. On average, the control treatment possessed twice the number of species than did any of the treatments. Thus, the signaling and the colonization effects of ABM seed treatments persist over time and impact not only the plant yield but also rhizosphere fungal make up and complexity.

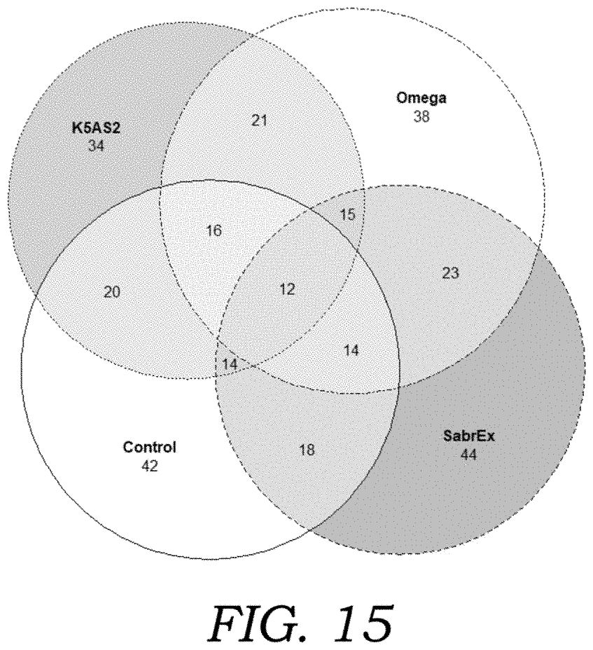

FIG. 15 depicts a Euler diagram showing bacterial inhabitants in a corn trial with a control, 2-Trichoderma strain treatment, Trichoderma-Bacillus treatment (K5AS2), and Trichoderma-metabolite treatment (Omega), wherein 16S is ribosomal RNA. A survey of rhizosphere bacterial inhabitants in a corn trial with control, Trichoderma strain treatment for corn (2 ABM Trichoderma strains), K5AS2 (ABM Trichoderma+Bacillus strains), or Trichoderma metabolite seed treatments was made. The rhizosphere inhabitants were surveyed at approximately the R1 stage or 10 weeks after planting. As with the fungal inhabitants of the previous Figures, the numbers within the diagram represent the observed number of bacterial organisms specifically present the applicable specific treatment. Areas where the circles overlap show numbers of organism in common between the multiple treatments. A small number of bacterial species were present in all treatments, as is represented in the Euler diagrams at right. The number of bacterial species present in each of the treatments was not significantly different, however the per treatment profiles were clearly unique. Thus, the signaling and colonization effects of ABM seed treatments persist over time and impact not only the plant yield but also rhizosphere bacterial make up.

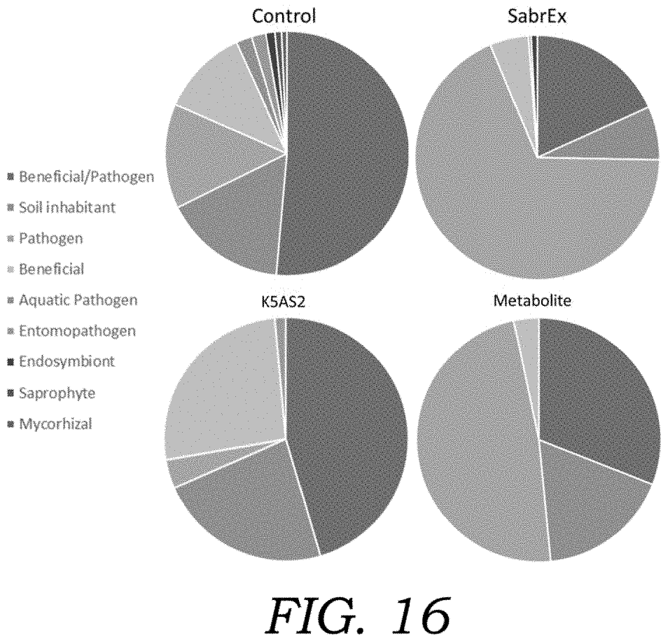

FIG. 16 depicts surveys of rhizosphere inhabitants in a corn trial with a control, 2-Trichoderma strain treatment, Trichoderma-Bacillus treatment (K5AS2), and Trichoderma-metabolite treatment (Omega). A survey of rhizosphere inhabitants in a corn trial with control, Trichoderma strain treatment for corn (2 ABM Trichoderma strains), K5AS2 (ABM Trichoderma+Bacillus strains), or Trichoderma metabolite (1-Octene-3-ol) seed treatments was made. The organism lifestyle metadata were analyzed for each treatment. Pie charts in FIG. 16 show the distribution of each treatment rhizosphere profile categorized by lifestyle. We observe a reduction in lifestyle diversity with respect to treatment. We observe an increase in the number of pathogens in Trichoderma strain treatment and Trichoderma metabolite treatments, that did not result in plant disease. We observe that the K5AS2 treatment, containing an ABM Bacillus strain showed the least diverse lifestyle pattern and a reduction in the number of pathogens. These pathogens also did not result in plant disease.

Plant gene expression analysis shows reduction in variability when colonized by Trichoderma. Plants colonized by Trichoderma show highly focused and reproducible patterns of gene expression. Uncolonized plants show highly variable gene expression. We propose that gene expression in plants colonized by Trichoderma responds specifically to that colonization and further that Trichoderma redirects plant gene expression to more targeted biological processes supporting Trichoderma niche development. Gene expression in uncolonized plants responds to the entire set of environmental factors present with relatively little process hierarchy.

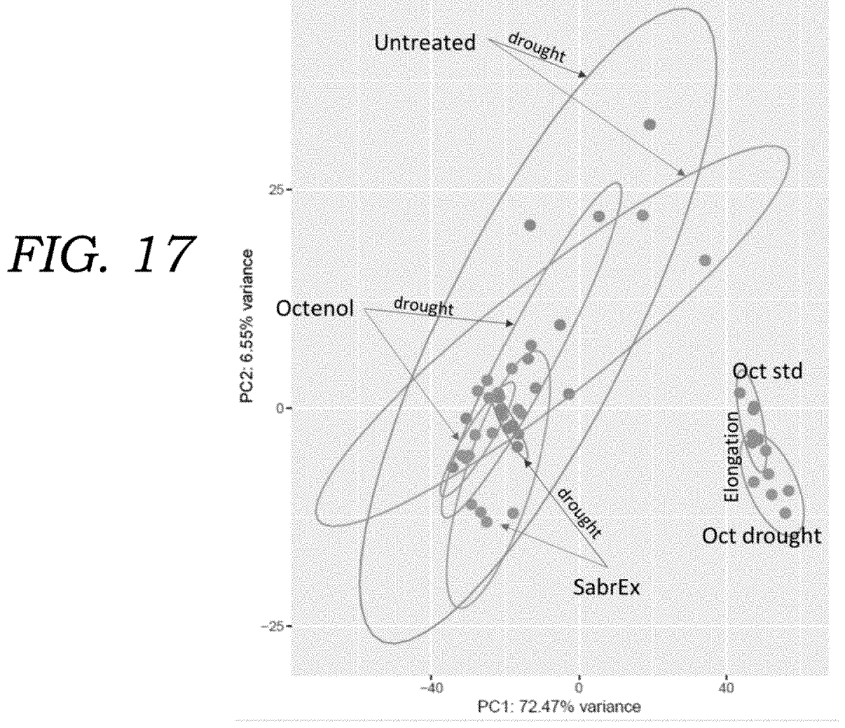

FIG. 17 depicts a representation of all gene expression in corn seedlings exposed to various seed treatments versus an untreated seed in both standard and drought conditions. FIG. 17 further groups the applicable replicates in order to convey variability, and data sets refer to principal component analysis, in order to evidence variability. All samples with the exception of the Trichoderma metabolite (1-Octene-3-ol), are root apical meristem (RAM) measurements. The sampling occurred from seeds that were grown for seven days before sampling. Observed variability was high in corn gene expression in standard and drought conditions. (See untreated). Application of Trichoderma strain treatment or Trichoderma metabolite 1-Octene-3-ol focusses gene expression. (see SabrEx and Oct). Thus, untreated plants are busy responding to a lot of environmental factors, Trichoderma strain treatment/1-Octene-3-ol treated plants are controlled somewhat by the treatment, which supports findings in previous RNAseq experiments, where correlation is shown by the reduction in microbiome diversity in the field, in the reduction of error bars in field performance data. This is a clear benefit of Trichoderma strain treatment and metabolite (1-Octene-3-ol). Reduction of variable performance in the field is therefore because the plant gene expression has been remodeled or refined by Trichoderma.

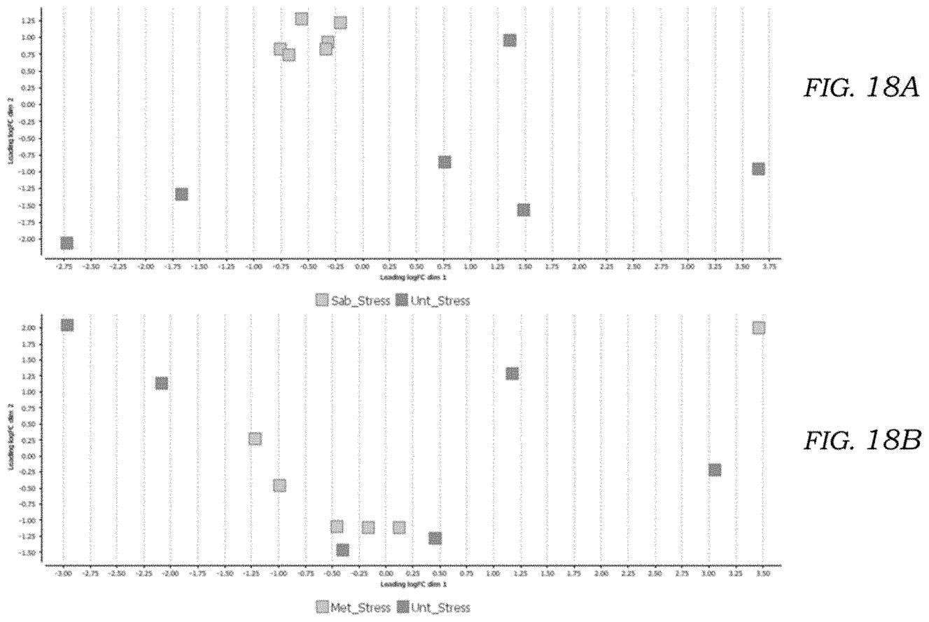

FIGS. 18A-B depict multidimensional scaling plots of corn gene expression when colonized by Trichoderma, particularly, 2-Trichoderma strain treatment and untreated in unstressed conditions. The graphs in FIGS. 18A-B are multidimensional scaling plots of RNAseq experiment described in previous figure. In both cases, dark gray squares are the untreated (no microbial treatment) drought condition. Light gray squares are Trichoderma strain treatment (2 ABM Trichoderma strains) or metabolite (1-Octene-3-ol) in the top and bottom, respectively. Each square represents the overall expression pattern for a single rep of the indicated treatment. Thus, the spread of the treatment squares is a measure of the repeatability or variability of that treatment. Trichoderma strain treatment results in a highly reproducible expression pattern relative to the highly variable untreated samples. Metabolite treatment shows a generally more reproducible expression pattern than the untreated. These data support both field and rhizosphere microbiome observations regarding ABM treatment reduction of performance variability.

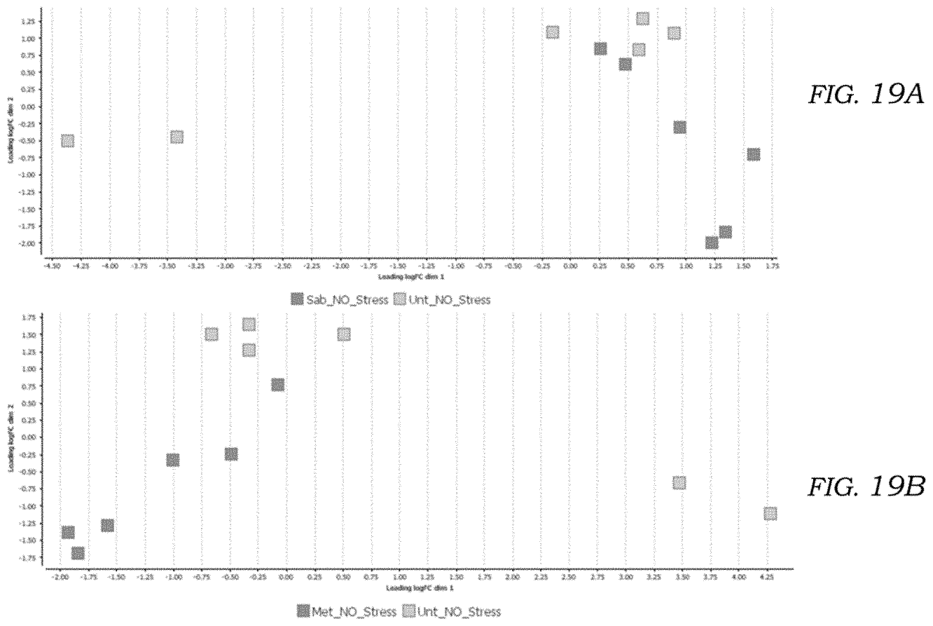

FIGS. 19A-B depict multidimensional scaling plots of corn gene expression when colonized by Trichoderma, particularly, 2-Trichoderma strain treatment and untreated in drought conditions. Graphs in FIGS. 19A-B are multidimensional scaling plots of RNAseq experiment described in previous figure. In both cases, light gray squares are the untreated (no microbial treatment) unstressed condition. Dark gray squares are Trichoderma strain treatment (2 ABM Trichoderma strains) or metabolite (1-Octene-3-ol) in FIGS. 19A and 19B, respectively. Each square represents the overall expression pattern for a single rep of the indicated treatment. Thus, the spread of the treatment squares is a measure of the repeatability or variability of that treatment. Trichoderma strain treatment results in a highly reproducible expression pattern relative to the highly variable untreated samples. Metabolite treatment shows a generally more reproducible expression pattern than the untreated. These data support both field and rhizosphere microbiome observations regarding ABM treatment reduction of performance variability. Spread along the x-axis of FIGS. 18A-B and 19A-B is more indicative of variability. Each replicate of this data is the representation of the measured mRNA at the time of collection.

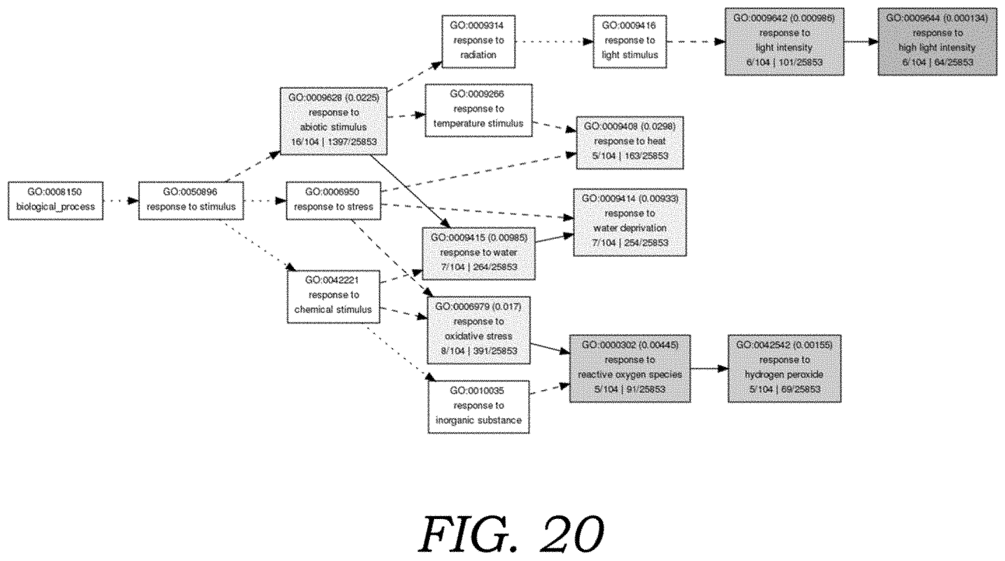

Turning to FIGS. 20-24, differential gene expression (Blast 2Go DGE) is measured, wherein the corresponding legend of FIG. 20 presents comparison to a control, wherein the higher scale shown (color or patterned), the higher level of upregulation has occurred.

FIG. 20 depicts a flow diagram of biological processes upregulated in maize having drought stress when treated with 2-Trichoderma strain treatment.

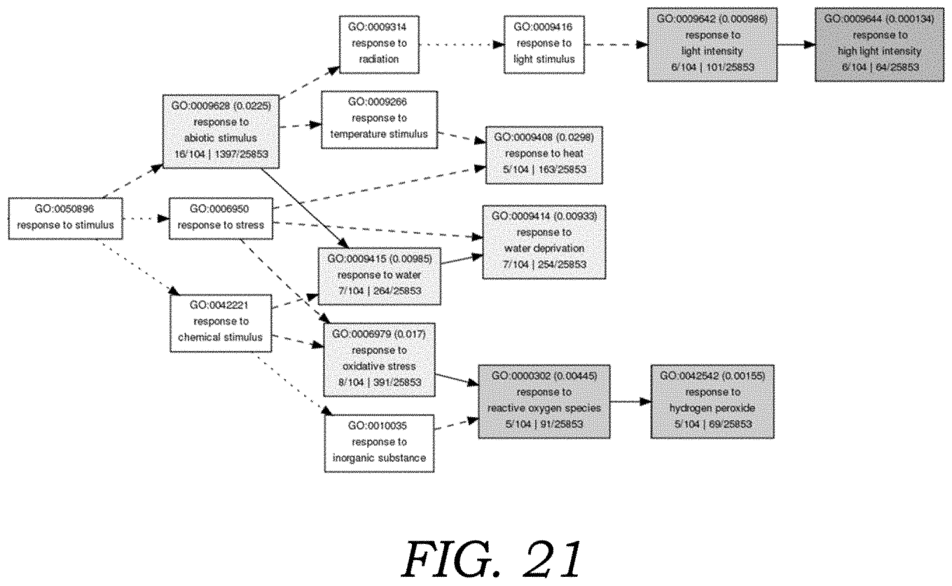

FIG. 21 depicts a flow diagram of shoot response upregulated in maize treated with 2-Trichoderma strain treatment, including response to: abiotic stimulus, water deprivation, high light intensity, oxidative stress/ROS, and H₂O₂; as well as Abiotic Stimulus, Water deprivation, High light intensity, Oxidative Stress/ROS, H₂O₂ for those treatments including a Trichoderma metabolite.

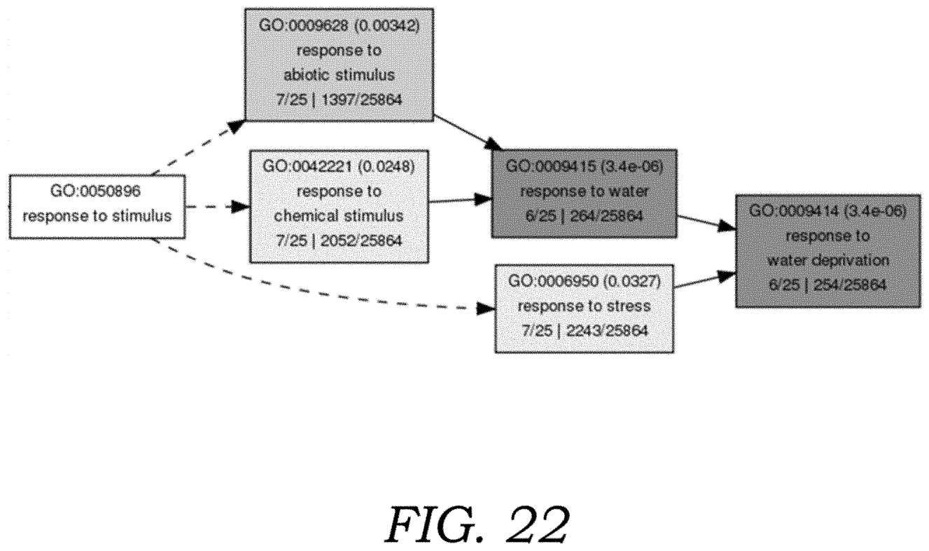

FIG. 22 depicts a flow diagram of shoot response upregulated in maize treated with a Trichoderma metabolite treatment, including response to: Abiotic stimulus, water deprivation, and chemical stimulus, as well as Abiotic Stimulus, Water deprivations, Chemical Stimulus for those treatments including a Trichoderma metabolite.

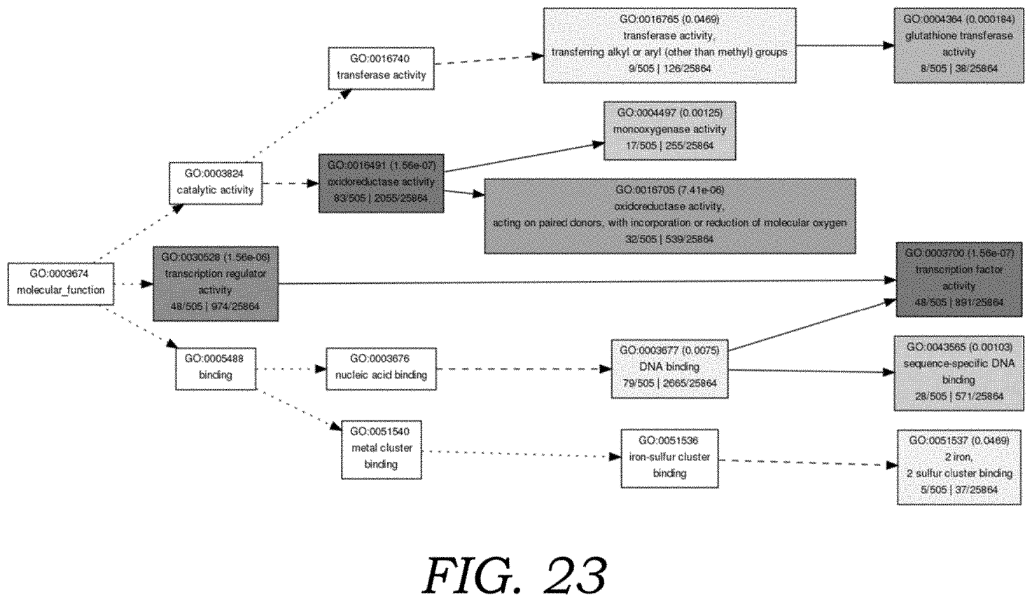

FIG. 23 depicts a flow diagram of molecular functions upregulated in corn treated with 2-Trichoderma strain treatment in a laboratory setting. The lab plants were grown in conical tubes with nutrient bath and to simulate osmotic stress from drought they added a polyethylene glycol (PEG) solution to the tubes.

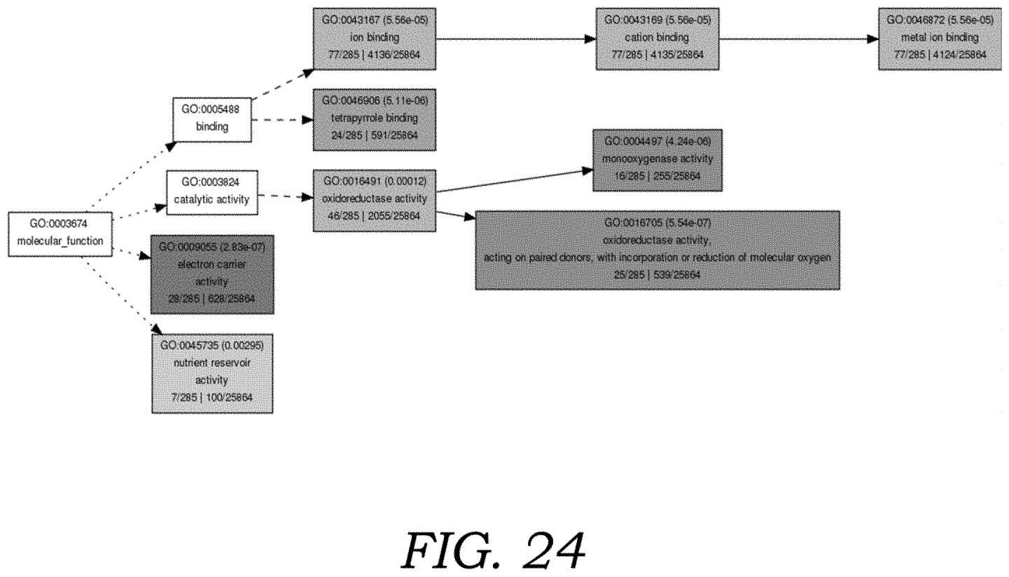

FIG. 24 depicts a flow diagram of molecular functions upregulated in corn treated with Trichoderma metabolite treatment in a laboratory setting. The lab plants were grown in conical tubes with nutrient bath and to simulate osmotic stress from drought they added a polyethylene glycol (PEG) solution to the tubes.

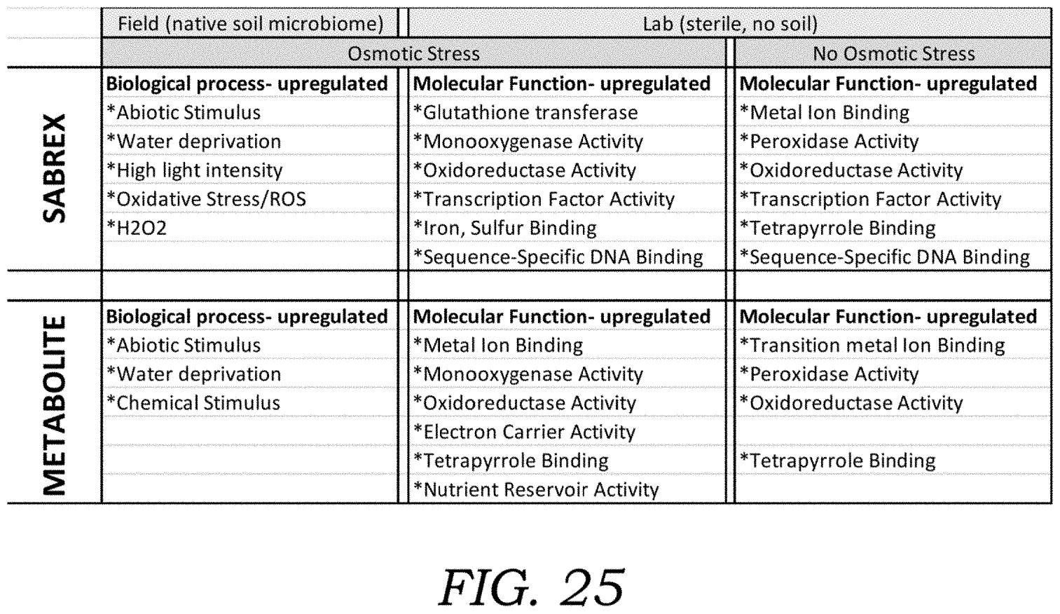

FIG. 25 depicts a table of changes in corn gene expression versus an untreated control in RNAseq experiments of FIGS. 20-24. Reference to “Lab (sterile, no soil)” is the data from the conical tube experiments of FIG. 23 and FIG. 24.

The present invention is not to be limited in terms of the particular embodiments described in this application, which are intended as single illustrations of individual aspects of the invention. Many modifications and variations of this invention can be made without departing from its spirit and scope, as will be apparent to those skilled in the art. Functionally equivalent methods and apparatuses within the scope of the invention, in addition to those enumerated herein, will be apparent to those skilled in the art from the foregoing descriptions. Such modifications and variations are intended to fall within the scope of the appended claims. The present invention is to be limited only by the terms of the appended claims, along with the full scope of equivalents to which such claims are entitled. It is to be understood that this invention is not limited to particular methods, reagents, compounds compositions or biological systems, which can, of course, vary. It is also to be understood that the terminology used herein is for the purpose of describing particular embodiments only, and is not intended to be limiting. In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth. All patents, patent applications, provisional applications, and publications referred to or cited herein are incorporated by reference in their entirety, including all figures and tables, to the extent they are not inconsistent with the explicit teachings of this specification.

### REFERENCES

Altschul, S. F., Gish, W., Miller, W., Myers, E. W. & Lipman, D. J. (1990) “Basic local alignment search tool.” J. Mol. Biol. 215:403-410.
Mastouri et al 2010. Phytopath. Seed treatment w/T. harzianum alleviates biotic, abiotic, physiolo . . . .
Shoresh and Harman 2008. Plant Physiol. Mol Basis of shoot responses . . . prot approach.
Fujibe, T., Saji, H., Arakawa, K., Yabe, N., Takeuchi, Y., and Yamamoto, K. T. 2004. A methyl viologen-resistant mutant of Arabidopsis, which is allelic to ozone-sensitive rcd1, is tolerant to supplemental ultraviolet B irradiation. Plant Physiol. 134:275-285.
Ahmad, P., A. Hashem, E. F. Abd-Allah, A. A. Alqarawi, R. John, D. Egamberdieva and S. Gucel (2015). “Role of Trichoderma harzianum in mitigating NaCl stress in Indian mustard (Brassica juncea L) through antioxidative defense system.” Front Plant Sci 6: 868.
Deng, F. and K. K. Hatzios (2002). “Characterization and Safener Induction of Multiple Glutathione S-Transferases in Three Genetic Lines of Rice.” Pesticide Biochemistry and Physiology 72(1): 24-39.
Lederer, B. and P. Böger (2003). “Binding and protection of porphyrins by glutathione S-transferases of Zea mays L.” Biochimica et Biophysica Acta (BBA)—General Subjects 1621(2): 226-233.
Mastouri, F., T. Bjorkman and G. E. Harman (2012). “Trichoderma harzianum enhances antioxidant defense of tomato seedlings and resistance to water deficit.” Mol Plant Microbe Interact 25(9): 1264-1271.
Sharma, R., A. Sahoo, R. Devendran and M. Jain (2014). “Over-expression of a rice tau class glutathione s-transferase gene improves tolerance to salinity and oxidative stresses in Arabidopsis.” PLoS One 9(3): e92900.

What is claimed is:

1. A method of stabilizing plant performance variability, comprising:
a. selecting one or more plants; and
b. applying to the selected plant or a seed of the plant a microbial treatment, wherein the microbial treatment:
(i) upregulates plant gene expression of stress mitigation processes; and
(ii) signals to the extant microbial community to initiate a rhizosphere response via alteration of microbiome composition;
wherein the plants exposed to the microbial treatment possess decreased variability in plant performance compared to plants that have not been exposed to the microbial treatment.

2. The method of claim 1, wherein the microbial treatment comprises microbial strains selected from a group consisting of: Trichoderma K1, Trichoderma K2, Trichoderma K3, Trichoderma K4, Trichoderma K5, Bacillus licheniformis, Bacillus amyloliquefaciens Beauvaria bassiana, Metarhizium pingshaence, and combinations thereof.

3. The method of claim 2, wherein the microbial treatment further comprises providing a microbial composition selected from a group consisting of Trichoderma K5; a combination of Trichoderma K2 and Trichoderma K4; a combination of Trichoderma K5 and Trichoderma K; a combination of Trichoderma K5 and Bacillus amyloliquefaciens; a combination of Trichoderma K1, Trichoderma K2, Trichoderma K3 and Trichoderma K4; a combination of Trichoderma K2, Trichoderma K4 and Beauvaria bassiana; and a combination of Trichoderma K2, Trichoderma K4, Metarhizium pingshaence and combinations thereof.

4. The method of claim 1, wherein the microbial treatment further comprises a microbial metabolite.

5. The method of claim 4, wherein the microbial metabolite is selected from the group consisting of: 6-pentyl pyrone, harzianic acid, hydtra 1, harzinolide and/or 1-octene-3-ol.

6. The method of claim 1, wherein the one or more plants, or the seeds from one or more plants, is selected from the group consisting of corn, alfalfa, rice, wheat, barley, oats, rye, cotton, sorghum, sunflower, peanut, potato, sweet potato, bean, pea, chicory, lettuce, endive, cabbage, cannabis, brussels sprout, beet, parsnip, turnip, cauliflower, broccoli, radish, spinach, onion, garlic, eggplant, pepper, celery, carrot, squash, pumpkin, zucchini, cucumber, apple, pear, melon, citrus, strawberry, grape, raspberry, pineapple, soybean, tobacco, tomato, maize, clover, sugarcane, Arabidopsis thaliana, Saintpaulia, petunia, pelargonium, poinsettia, chrysanthemum, carnation, zinnia, roses, snapdragon, geranium, zinnia, lily, daylily, Echinacea, dahlia, hosta, tulip, daffodil, peony, phlox, herbs, ornamental shrubs, ornamental grasses, switchgrass, and turfgrass, or any other plant or seed or crop, or combinations thereof.

7. The method of claim 1, wherein the microbial treatment imparts plant resistance as selected from a group consisting of: upregulation of plant biological processes, altering plant gene expression antagonistic to plant stress, long term changes in plant gene expression via epigenetic regulation and/or signaling, and combinations thereof.

8. The method of claim 1, wherein the microbial treatment imparts plant resistance by an upregulated biological process in response to plant stress selected from a group consisting of: abiotic stimulus, water deprivation, high light intensity, oxidative stress/ROS, hydrogen peroxide (H₂O₂), chemical stimulus, and combinations thereof.

9. The method of claim 1, wherein the microbial treatment imparts plant resistance through upregulation of plant molecular function.

10. The method of claim 1, wherein the microbial treatment imparts plant resistance through upregulation of plant molecular function selected from the group consisting of: glutathione transferase products, monooxygenase activity, oxidoreductase activity, transcription factor activity, iron/sulfur binding, sequence-specific DNA binding, metal ion binding, electron carrier activity, tetrapyrrole binding, nutrient reservoir activity, microRNA activity, and combinations thereof.

11. The method of claim 1, wherein a microbial agent present in the microbial treatment colonizes the root of the plant.

12. The method of claim 1, wherein the application of the microbial treatment comprises coating the plant or the plant seed or the planting medium with the microbial treatment.

13. The method of claim 1, wherein the application of the microbial treatment is selected from a means or group consisting of broadcast application, aerosol application, spray-dried application, liquid, dry, powder, mist, atomized, semi-solid, gel, coating, lotion, linked or linker material, material, in-furrow application, spray application, irrigation, injection, dusting, pelleting, or coating of the plant or the plant seed or the planting medium with the microbial treatment.

14. The method of claim 1, wherein the reduced variability comprises reduction of field level variability.

15. The method of claim 1, wherein the reduced variability is selected from a group consisting of: reduction in the phytobiome of the plant, reduction of the functional diversity of microbial species present in the phytobiome of the plant, comprises stabilization of gene expression of genes selected from the group consisting of: stress mitigation genes, molecular functions genes, biological process genes, and combinations thereof, stabilization of plant yield, stabilization of harvest quality, stabilization of plant gene expression, and combinations thereof.

16. A microbial treatment composition for stabilization of variability of plant performance, comprising:
a. at least one microbial treatment; and
b. a means for localized application of the at least one microbial treatment to one or more plants, or a seed from the one or more plants, wherein the localized application imparts upregulation of gene expression in the one or more plants;
wherein the one or more plants exposed to the microbial treatment possess increased plant performance compared to plants that have not been exposed to the microbial treatment.

17. The microbial treatment composition of claim 16, wherein the microbial treatment comprises microbial strains selected from the group consisting of: K1 (Trichoderma vixens—ATCC #20906); K2 (Trichoderma afroharzian—ATCC # PTA-9708); K3 (Trichoderma afroharzian—ATCC # PTA-9709); K4 (Trichoderma atroviride—ATCC # PAT-9707); and K5 (Trichoderma atroviride—NRRL # B-50520).

18. The microbial treatment composition of claim 16, wherein the microbial treatment further comprises a microbial metabolite selected from a group consisting of: 6-pentyl pyrone, harzianic acid, hydtra 1, harzinolide and/or 1-octene-3-ol.

19. The microbial treatment composition of claim 16, wherein the one or more plants, or the seed of one or more plants, is selected from the group consisting of corn, alfalfa, rice, wheat, barley, oats, rye, cotton, sorghum, sunflower, peanut, potato, sweet potato, bean, pea, chicory, lettuce, endive, cabbage, cannabis, brussels sprout, beet, parsnip, turnip, cauliflower, broccoli, radish, spinach, onion, garlic, eggplant, pepper, celery, carrot, squash, pumpkin, zucchini, cucumber, apple, pear, melon, citrus, strawberry, grape, raspberry, pineapple, soybean, tobacco, tomato, maize, clover, sugarcane, Arabidopsis thaliana, Saintpaulia, petunia, pelargonium, poinsettia, chrysanthemum, carnation, zinnia, roses, snapdragon, geranium, zinnia, lily, daylily, Echinacea, dahlia, hosta, tulip, daffodil, peony, phlox, herbs, ornamental shrubs, ornamental grasses, switchgrass, and turfgrass, or any other plant or seed or crop, or combinations thereof.

20. The microbial treatment composition of claim 16, wherein the microbial treatment is selected from the group consisting of Bradyrhizobium spp., Trichoderma spp., Bacillus spp., Pseudomonas spp. and Clonostachys spp. or any combination thereof.

21. The microbial treatment composition of claim 16, wherein the microbial treatment imparts plant resistance selected from a group consisting of: upregulation of plant biological processes, altering plant gene expression antagonistic to plant stress, long term changes in plant gene expression via epigenetic regulation and/or signaling, and combinations thereof.

22. The microbial treatment composition of claim 29, wherein the upregulated biological processes are in response to plant stress selected from a group consisting of: abiotic stimulus, water deprivation, high light intensity, oxidative stress/ROS, hydrogen peroxide (H₂O₂), chemical stimulus, and combinations thereof.

23. The microbial treatment composition of claim 16, wherein the microbial treatment imparts plant resistance through upregulation of plant molecular function selected from the group consisting of: glutathione transferase products, monooxygenase activity, oxidoreductase activity, transcription factor activity, iron/sulfur binding, sequence-specific DNA binding, metal ion binding, electron carrier activity, tetrapyrrole binding, nutrient reservoir activity, microRNA activity, and combinations thereof.

24. The microbial treatment composition of claim 16, wherein a microbial agent present in the microbial treatment colonizes the root of the plant.

25. The microbial treatment composition of claim 16, wherein the application of the microbial treatment to the one or more plants, or a seed from the one or more plants, is selected from a means or group consisting of broadcast application, aerosol application, spray-dried application, liquid, dry, powder, mist, atomized, semi-solid, gel, coating, lotion, linked or linker material, material, in-furrow application, spray application, irrigation, injection, dusting, pelleting, or coating of the plant or the plant seed or the planting medium with the microbial treatment.

26. The microbial treatment composition of claim 16, wherein said treatment confers reduced variability selected from a group consisting of: reduction of field level variability, reduction in the phytobiome of the plant, reduction of the functional diversity of microbial species present in the phytobiome of the plant, stabilization of gene expression of genes selected from the group consisting of: stress mitigation genes, molecular functions genes, biological process genes, and combinations thereof, stabilization of plant yield, stabilization of harvest quality, stabilization of plant gene expression, and combinations thereof.
